(19) United States
(12) Patent Application Publication
(10) Pub. No.: US 2024/0051099 A1
(43) Pub. Date: Feb. 15, 2024

(54) METHOD FOR PRODUCING A SCREW CONNECTION

(71) Applicant: HELLA GmbH & Co. KGaA, Lippstadt (DE)

(72) Inventors: Ingo ENGLER, Soest (DE); Ferdinand HELLE, Lippstadt (DE); Frank JAGOW, Erwitte/Bad Westernkotten (DE); Odo KARGER, Geseke (DE); Sven KINKEL, Borchen (DE); Miguel LEBRATO-RASTROJO, Paderborn (DE); Thomas Albert ROEBBECKE, Erwitte (DE); Konrad SCHUERHOFF, Rietberg (DE)

(73) Assignee: HELLA GmbH & Co. KGaA, Lippstadt (DE)

(21) Appl. No.: 18/382,774

(22) Filed: Oct. 23, 2023

Related U.S. Application Data
(63) Continuation of application No. PCT/EP2022/059131, filed on Apr. 6, 2022.

(30) Foreign Application Priority Data
Apr. 23, 2021 (DE) 10 2021 110 411.4

(51) Int. Cl. B25B 23/147

(52) U.S. Cl. CPC B25B 23/147

(57) ABSTRACT

A method for producing a screw connection having a screw that is set in rotational motion with a screwdriving head of a screwdriving tool. The screwdriving head has a motor drive for creating the rotational motion of a screw receptacle of the screwdriving head. The screw is driven into at least one mating part of the screw connection in a rapid speed. A torque is detected with which the screw is driven. The rapid speed with a higher rotational speed is changed to a creep speed with a lower rotational speed at a changeover time. The changeover time is determined as a function of the detected torque during screwdriving at rapid speed. The screw is further driven at the creep speed until a head contact time when a head of the screw makes contact on the mating part.

This nonprovisional application is a continuation of International Application No. PCT/EP2022/059131, which was filed on Apr. 6, 2022, and which claims priority to German Patent Application No. 10 2021 110 411.4, which was filed in Germany on Apr. 23, 2021, and which are both herein incorporated by reference.

### BACKGROUND OF THE INVENTION

### Field of the Invention

The present invention relates to a method for producing a screw connection by means of a screw that is set in rotational motion with a screwdriving head of a screwdriving tool, wherein the screwdriving head has a motor drive for creating the rotational motion of a screw receptacle of the screwdriving head.

### Description of the Background Art

DE 10 2019 114 421 B3, which is incorporated herein by reference, discloses a screwdriving tool in the form of an articulated arm robot, and a screwdriving head is arranged on the final axis of the articulated arm, and the screwdriving head has a motor drive in order to rotationally drive a screw receptacle for receiving a screw. Such screwdriving tools are employed in at least partially automated assembly, wherein generally the goal is pursued of achieving the shortest possible cycle times of the successive screwdriving cycles.

In the conventional art, a significant time component of a screwdriving cycle is driving the screw into at least one mating part that is to be connected by the screw to, for example, a second mating part. Thus, it is routinely necessary to fasten components that are to be installed in a plastic housing of a lighting device of a motor vehicle, for example, to screw bosses, for which purpose the screw must be driven into the screw boss after positioning of the mating parts relative to one another. In this process, it is necessary to maintain a required torque for tightening the screw, which torque must arise at the time when the head of the screw makes contact. As a result of sensor-based detection of the head contact time, the rotational motion of the screw receptacle usually is stopped abruptly, wherein the deceleration of the rotational motion from high rotational speeds frequently is problematic, so excessively high torques for tightening the screw may arise.

DE 42 31 429 C1 proposes the use of ultrasound that is introduced into the screw, for example. It is possible to determine by means of the acoustic behavior of the screw whether the screw is being tightened under load so as to stop the electric drive as soon as possible in this respect. However, faster-running motor drives, especially in connection with a transmission, for example a planetary transmission, fundamentally cannot be stopped quickly enough to avoid an overshoot of the torque for tightening the screw. If the rotational speed for screwing in the screw is reduced, however, then the cycle times are in turn lengthened in an undesirable manner.

### SUMMARY OF THE INVENTION

It is therefore an object of the invention to provide a method for producing a screw connection with cycle times that are as short as possible, wherein a specified torque for tightening the screw is to be maintained despite a short cycle time.

In an exemplary embodiment, the method according to the invention provides at least the following steps to attain the object: driving the screw into at least one mating part of the screw connection in a rapid speed, detecting a torque with which the screw is driven into the mating part, changing from the rapid speed with a higher rotational speed to a creep speed with a lower rotational speed at a changeover time, wherein the changeover time is determined as a function of the detected torque during screwdriving at rapid speed, and further driving of the screw at the creep speed until a head contact time when a head of the screw makes contact on the mating part.

A concept of the invention is the utilization of the torque curve during driving of the screw even before the head contact time in order to determine the upcoming head contact time on the basis of the torque curve and to effect the changeover time for changing from rapid speed to creep speed even before the head contact time. In this process, the effect is utilized that the torque for driving the screw grows with increasing depth of thread engagement of the screw, in particular of a self-tapping screw in a plastic component, for example in a screw boss, and a triggering torque can be defined from which the upcoming head contact time can be determined statistically.

The invention attains the object inasmuch as the rapid speed can continue as long as possible, and the creep speed can be approached for just a short period until the head contact time. The deceleration by the motor drive of the rotational motion from the creep speed is to the increase in the torque and until the approach of a tightening torque for tightening the screw can be accomplished with a conventional screwdriving head. The approach from the rapid speed cannot be accomplished far enough to establish the desired tightening torque, however, since the dynamics of the motor drive of a screwdriving head typically do not suffice for this purpose. The invention circumvents this situation by the means that the changeover time from the rapid speed to the creep speed is set to as short a time as possible before the head contact time. The higher rotational speed at the rapid speed is to be viewed as relative to the lower rotational speed at the creep speed and vice versa.

To further advantage, the screwdriving tool has a torque detection device with which the torque that is present at the screw receptacle during driving of the screw into the at least one mating part is detected and processed by means of a controller of the screwdriving tool. The torque detection device can constitute a torque measuring cell that is configured on the motor drive or on a downstream transmission between the motor drive and the screw receptacle. However, it is also possible to place the torque detection device in operative connection with the input current or the input power of the motor drive, from which a torque can be inferred on an ongoing basis as well.

To further advantage, a specifiable remaining rapid speed time is started when a triggering torque is reached during the detection of the torque over the process time of the rapid speed, after which the rapid speed is terminated again and the creep speed is continued. The remaining rapid speed time can be statistically determined in advance for the programming of a controller for carrying out the method, for example in a series of test cycles during which the time interval elapses between reaching the triggering torque, measured with the torque detection device, and the head contact time. This statistically determined remaining rapid speed time is taken as a basis of the process control for the screwdriving cycle.

The remaining rapid speed time can be specified such that there is still a minimum time for the creep speed between the end of the rapid speed at the changeover time and the head contact time. This minimum time should be as short as possible in the determination of the remaining rapid speed time, wherein a deceleration time until a deceleration end time must also continue to be taken into account in the specification of the remaining rapid speed time when the drive changes the rotational speed from the rapid speed to the creep speed. In this respect, the actual creep speed lasts only from the deceleration end time until the head contact time.

The rotational speed of the rapid speed can be 160 RPM to 200 RPM and preferably 180 RPM, and/or the rotational speed of the creep speed can be determined as 40 RPM to 60 RPM and preferably 50 RPM.

To further advantage, the torque continues to be monitored during the minimum time of the creep speed, wherein the minimum time of the creep speed is ended at the head contact time, and the time of the head contact is determined by the torque detection, which identifies a sharp increase in the torque at the time of head contact. The controller is programmed appropriately for this purpose and drives the motor drive of the screwdriving head, wherein the controller is brought into operative connection with the torque detection device, in particular, so that the controller continuously receives torque values from the torque detection device over the entire screwdriving cycle, and ultimately drives the motor drive with a suitable control system.

In this case the controller, in operative connection with the motor drive, determines the torque after its increase at the head contact time in precisely such a way that a fastening of the screw with a specified tightening torque takes place up until an end time. After the cessation of the rotational motion, the screw receptacle is detached from the screw.

The angular acceleration of the screw receptacle until the rotational speed of the rapid speed is reached and the angular deceleration of the screw receptacle from the rotational speed of the rapid speed until the rotational speed of the creep speed is reached can advantageously be set equal to one another, wherein, in particular, the angular acceleration and/or the angular deceleration is/are determined with a value of approximately 800°/s².

The invention is additionally directed toward a screwdriving tool for producing a screw connection by means of a screw, having a screwdriving head with a screw receptacle that can be set in rotational motion with the screwdriving head, for which purpose the screwdriving head has a motor drive, and wherein the screwdriving tool is designed to carry out a method for producing a screw connection. In particular, the screwdriving tool has a controller for this purpose that is programmed to carry out the steps of the method according to the invention.

The invention is additionally directed toward a software program product for operating a controller of a screwdriving tool.

The screwdriving tool is designed, in particular, as an articulated arm robot with a multi-link articulated arm, in which a final articulated arm link of the articulated arm is at least partially rotatable in an axis of rotation and forms the screwdriving head. To particular advantage, the motor drive forms a part of the final articulated arm link of the articulated arm robot, wherein articulated arm robots are known in which the final articulated arm link is rotatable about an axis. In this respect, the motor drive can also be part of the articulated arm robot, and the screwdriving head advantageously is also formed, at least in part, by the final articulated arm link of the articulated arm robot, in particular in order to create the rotational motion directly with the final articulated arm link itself, so that it is not necessary to first incorporate a drive module in the robot as well. The controller for carrying out the method can be configured peripherally, or, to particular advantage, the controller is the controller, or a part of the controller, of the robot itself.

To still further advantage, the screwdriving head can have a planetary transmission that is configured in the screwdriving head between the rotary drive and the screw receptacle such that the screw receptacle executes a higher rotational speed and/or a doubled and/or a tripled rotational speed as compared with the rotational speed of the motor drive. The torque detection device is, in particular, also accommodated in the screwdriving head and/or is designed to be integrated in the transmission or in the electric drive.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a view of a screwdriving tool for producing a screw connection, wherein the screwdriving tool is designed as an articulated arm robot, and

FIG. 2 shows a graph in which the rotational speed and the torque that are present at the screw receptacle are plotted over the process time, and a process cycle for producing a screw connection is shown in the graph.

### DETAILED DESCRIPTION

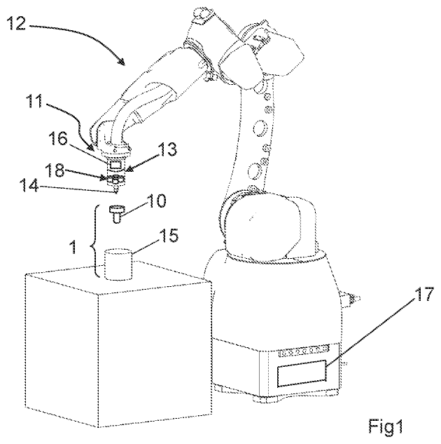

FIG. 1 shows a view of a screwdriving tool 12 in the form of an articulated arm robot with an articulated arm, and a final articulated arm link of the articulated arm forms a screwdriving head 11. The screwdriving head 11 has a motor drive 13, with which a screw receptacle 14 for receiving a screw 10 can be set in rotation. If the screw 10 is driven into the mating part 15 shown, the screw connection 1 can be produced as a result, wherein a second mating part is not represented for purposes of simplicity.

The screwdriving head 11 is furthermore shown with a planetary transmission 18, and the screw receptacle 14 is mounted on the output of the planetary transmission 18. In contrast, the motor drive 13, which is, in particular, a component of the screwdriving head 11 and thus a component of the articulated arm robot, is in operative connection with the transmission input of the planetary transmission 18, and the planetary transmission can create a step-up ratio with the factor of three, as an example, so that the rotational speed of the screw receptacle 14 is three times the rotational speed of the motor drive 13.

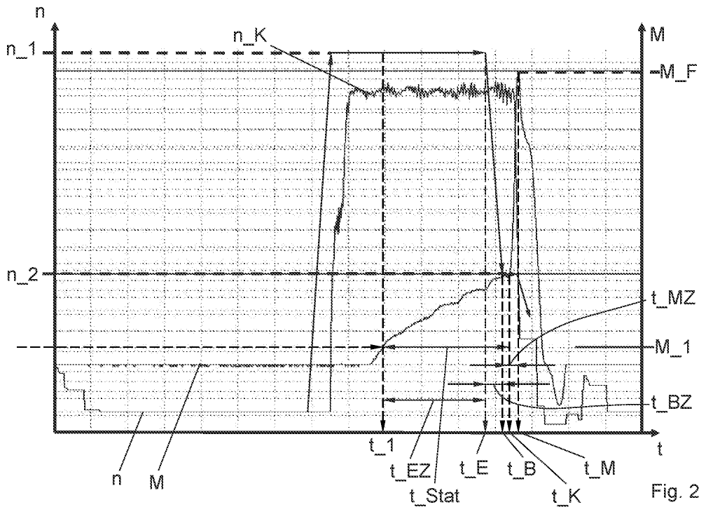

The screwdriving tool 12 is depicted with a controller 17; in addition to the arm motion of the articulated arm of the screwdriving tool 12, can also control the rotational speed, and thus the screwdriving cycle, with the controller 17, as shown in the following FIG. 2.

FIG. 2 shows a graph in which the rotational speed n is plotted on the left and the torque M at the screw receptacle 14 of the screwdriving head 11 is plotted on the right.

A screwdriving cycle is represented over the process time t, wherein the curve of the rotational speed n and the curve of the torque M are plotted, each of which initially has the value 0. The process cycle begins with the increase of the rotational speed to a rotational speed of a rapid speed n_1, wherein the rapid speed n_1 is held constant. When the screw now engages in the screw boss, an increase in the torque M results, as is evident from the curve. The increase in the torque M results from the increasing depth of thread engagement of the screw in the screw boss, which becomes evident as, in particular, an approximately linear increase when a screw is driven into a plastic component.

The controller monitors the behavior of the torque M in this process, and the identification of a triggering torque M_1 is programmed in the controller, which triggering torque is identified at the triggering time t_1 with the torque detection device. This triggering torque M_1 is determined by prior statistical investigations, and the investigations identify the statistically determined operating time t_Stat that elapses until a head contact time t_K. In this respect, the triggering torque M_1 is stored in the controller as a triggering signal, and when the torque detection device detects the torque M with the value of the triggering torque M_1, in accordance with the invention the remaining rapid speed time t_EZ is started, which time ends even before the head contact time in accordance with the statistical determination.

When the remaining rapid speed time t_EZ ends, the rotational speed n is changed at the changeover time LE from the rapid speed n_1 to a creep speed n_2. The rotational speed n of the rapid speed n_1 is 180 RPM, for example, while the rotational speed n of the creep speed n_2 is approximately 50 RPM. The minimum time of the creep speed t_MZ up until the head contact time LK starts to elapse as of the deceleration end time t_B. The sharp torque increase takes place up until the torque M_F, which represents the tightening torque for tightening the screw, and only a short time elapses until the end time t_M. Then the rotational motion of the screw receptacle stops when the torque M_F is reached, and the torque is reduced to zero. Subsequently, the screw receptacle is detached from the screw.

The result is a short process cycle, since the rapid speed n_1 is maintained as long as possible but the head contact time t_K is not taken as a basis for ending the rapid speed n_1, because the tightening torque M_F cannot be approached from the rapid speed n_1 since the dynamics of the screwdriving head do not suffice for this purpose. Since the minimum time of the creep speed t_MZ is still configured shortly before the head contact time t_K, however, the required tightening torque M_F can be approached from the lower rotational speed since the dynamics of the screwdriving head starting from creep speed n_2 are sufficient.

The invention is not limited in its implementation to the preferred exemplary embodiment provided above. Instead, a number of variants are possible that make use of the described solution even in embodiments that are fundamentally different in nature. All features and/or advantages, including design details, spatial arrangements, and method steps, that derive from the claims, the description, or the drawings, can be essential for the invention individually as well as in a wide variety of combinations.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a screw connection via a screw that is set in rotational motion with a screwdriving head of a screwdriving tool, the screwdriving head having a motor drive to create the rotational motion of a screw receptacle of the screwdriving head, the method comprising:
driving the screw into at least one mating part of the screw connection in a rapid speed;
detecting a torque with which the screw is driven into the mating part;
changing from a rapid speed with a higher rotational speed to a creep speed with a lower rotational speed at a changeover time, the changeover time being determined as a function of the detected torque during screwdriving at rapid speed; and
further driving of the screw at creep speed until a head contact time when a head of the screw makes contact on the mating part.

2. The method according to claim 1, wherein the screwdriving tool has a torque detection device with which the torque that is present at the screw receptacle during driving of the screw into the at least one mating part is detected and processed by a controller of the screwdriving tool.

3. The method according to claim 1, wherein a specifiable remaining rapid speed time is started at a triggering time when a triggering torque is reached during the detection of the torque over the process time of the rapid speed, after which the rapid speed is terminated again at the changeover time and the creep speed is continued.

4. The method according to claim 3, wherein the remaining rapid speed time is specified such that there is still a minimum time for the creep speed between the end of the rapid speed at the changeover time and the head contact time.

5. The method according to claim 1, wherein a deceleration time until a deceleration end time continues to be taken into account in the specification of the remaining rapid speed time.

6. The method according to claim 1, wherein the rotational speed of the rapid speed is 160 RPM to 200 RPM or is 180 RPM, and/or wherein the rotational speed of the creep speed is 40 RPM to 60 RPM or is 50 RPM.

7. The method according to claim 1, wherein the torque continues to be monitored during the minimum time of the creep speed, wherein the minimum time of the creep speed is ended at the head contact time, which is identified by the controller on the basis of a torque increase.

8. The method according to claim 1, wherein the controller determines the torque after its increase at the head contact time such that that a fastening of the screw with a specifiable tightening torque takes place up until an end time.

9. The method according to claim 1, wherein the angular acceleration of the screw receptacle until the rotational speed of the rapid speed is reached and the angular deceleration of the screw receptacle from the rotational speed of the rapid speed until the rotational speed of the creep speed is reached are set equal to one another and/or in that the angular acceleration and the angular deceleration are determined with a value of 800°/s².

10. A screwdriving tool for producing a screw connection via a screw, the screwdriving tool comprising:
a screwdriving head; and
a screw receptacle adapted to be set in rotational motion with the screwdriving head, for which the screwdriving head has a motor drive,
wherein the screwdriving tool is adapted to carry out the method according to claim 1.

11. The screwdriving tool according to claim 10, wherein the screwdriving tool has a controller with which the method is carried out.

12. The screwdriving tool according to claim 10, wherein the screwdriving tool is designed as an articulated arm robot with a multi-link articulated arm, in which a final articulated arm link of the articulated arm is rotatable in an axis of rotation and forms the screwdriving head.

13. The screwdriving tool according to claim 10, wherein the motor drive is part of the final articulated arm link of an articulated arm robot or forms the same.

14. The screwdriving tool according to claim 10, wherein the screwdriving head has a planetary transmission that is configured in the screwdriving head between the motor drive and the screw receptacle such that the screw receptacle executes a higher and/or a doubled and/or a tripled rotational speed as compared with the rotational speed of the motor drive.

15. The screwdriving tool according to claim 10, wherein the screwdriving head has a torque detection device.
